(19) United States
(12) Patent Application Publication
(10) Pub. No.: US 2018/0170084 A1
(43) Pub. Date: Jun. 21, 2018

(54) RAZOR BLADES

(71) Applicant: The Gillette Company LLC, Boston, MA (US)

(72) Inventors: Robert Board, Basingstoke (GB); Matthew Scott, Liverpool (GB); Mark Sheridan, Surrey (GB)

(21) Appl. No.: 15/841,391

(22) Filed: Dec. 14, 2017

Related U.S. Application Data
(60) Provisional application No. 62/436,127, filed on Dec. 19, 2016.

(51) Int. Cl. B41M 5/24; B26B 21/58; B21D 53/64

(52) U.S. Cl. CPC B41M 5/24; B26B 21/18; B21D 53/645; B26B 21/58

(57) ABSTRACT

This invention relates to razor blades, and more particularly to laser produced markings on razor blades and processes thereof.

### FIELD OF THE INVENTION

This invention relates to razor blades, and more particularly to markings on razor blades and processes thereof.

### BACKGROUND OF THE INVENTION

It is generally known in the prior art that razor blade edges (e.g., double edge) are visibly marked on outer surfaces, if at all, with ink such as solvent-based ink. These inks are currently applied onto the surfaces of the blade edges via a printer and printing processes. In some instances, both sides are marked with the ink. The ink markings are typically trade names (e.g., GILLETTE®), other text, designs and/or graphics.

One disadvantage of the prior art ink markings is the hazardous attribute of the printing solvent based-ink itself and solvent thinners. The ink material can be considered harmful if inhaled and highly flammable. Another disadvantage is that in some instances, the marking is removed and is not permanent. In other instances, the marking can be printed in an inconsistent fashion. With some printers, the energy utilized for printing ink processes is excessive.

It is desired to provide enhanced markings and processes thereof, on razor blade surfaces.

### SUMMARY OF THE INVENTION

The present invention relates to a method and apparatus of laser produced markings on razor blades. A method of providing a marking on razor blades of the present invention includes the steps of providing one or more lasers, the one or more lasers producing one or more markings on the razor blades, the razor blades connected on at least one strip. The one or more laser produced markings are produced using a laser marking process, a laser etching process or a laser engraving process, or any combination thereof. The razor blades include double edge or single edge razor blades. The one or more laser produced markings are disposed on a body portion of each razor blade on the at least one strip. The at least one strip of razor blades is comprised of steel. The one or more laser produced markings are formed on the at least one steel strip after a perforating process. The one or more laser produced markings are formed on the at least one steel strip before, after, or simultaneously with, a hardening process. The one or more laser produced markings formed on surfaces of the razor blades on the at least one strip leave the surfaces intact. The steel strip may be coated. The one or more laser produced markings comprise graphics, text, or any combination thereof. The one or more markings may be an accurate date code. The date code is disposed transverse to a cutting edge of the razor blade. The method further includes the steps of perforating, washing, or hardening. The system is an in-line system.

In another embodiment, the razor blade of the present invention includes one or more markings disposed by one or more lasers, the laser markings applied to a surface of a steel strip. The strip is perforated. The laser marking is formed before, after, or simultaneous with, a hardening process. The one or more markings are produced using a laser marking process, a laser etching process or a laser engraving process, or any combination thereof. The razor blade includes a double edge or a single edge razor blade. The one or more markings are disposed on a body portion of the razor blade.

In yet another embodiment, the razor blade of the present invention includes an accurate date marking. The accurate date marking is in a code format. The accurate date code marking is disposed on a surface of the razor blade using one or more lasers. A clock of the one or more lasers is used to provide an accurate date for the date marking. The accurate date marking is disposed transverse to a cutting edge of the razor blade.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is a razor blade of the double edge type showing ink markings of the prior art.

FIGS. 2A and 2B are flow diagram processes of the present invention.

FIG. 3 depicts the laser marking process of the present invention.

FIG. 4 depicts the laser marking process of the present invention.

FIG. 5 shows razor blades of the double edge type showing laser markings in accordance with the present invention.

FIG. 6 depicts an accurate date code marking of the present invention.

### DETAILED DESCRIPTION OF THE INVENTION

The present invention provides a novel process comprising lasers to produce markings on razor blades and in particular providing laser markings on razor blade surfaces. Laser produced markings, as compared to ink or other traditional marking techniques, offer some advantages in that the process is faster, can be performed on a number of materials, may be more legible over time, assists in providing an accurate date code, provide more font options, while not damaging or deforming the product.

The term “laser” as used herein signifies the acronym that stands for Light Amplification by the Stimulated Emission of Radiation. By raising the energy level of atoms to an excited state, these atoms release light as they fall back to their original energy, or ground state, thereby producing a laser. Once this beam of light is created, it is amplified in some way to produce a focal point. As the atoms begin to move, they create a weak light, and as more and more energy is added, the light waves become even more concentrated. Unlike with other types of light (such as a flashlight), the light rays of lasers all have the same wavelength and are coherent, which is what makes it such a powerful concentration of energy.

A type of laser process referred to as laser marking is a preferred process of the present invention. Laser marking is often referred to as laser coloration or laser dark marking, as well as charring for plastic materials and annealing for metals. There are four common types of laser marking: annealing, carbon migration, foaming and coloration.

Laser marking is the result of the light beam interacting with the surface of a material, slightly altering its properties or appearance. Laser marking is achieved by moving a low-powered beam slowly across the material using a method called discoloration, which creates high-contrast marks without disrupting the material. The laser heats the material, causing oxidation under the surface and turning the material black. It applies low temperatures to metal to anneal the surface. All of this is done while leaving the surface intact.

The present invention contemplates the use of laser engraving and laser etching as well as laser marking. It should be noted however that laser marking differs from laser engraving and laser etching. The most significant way that these three laser processes differ is that laser marking leaves the surface of the material intact, while laser etching and laser engraving both impact the surface.

Laser engraving is a process where the laser beam physically removes the surface of the material to expose a cavity that reveals an image at eye level. The laser creates high heat during the engraving process, which essentially causes the material to vaporize. It is generally a quick process, as the material is vaporized with each pulse. This creates a cavity in the surface that is noticeable to the eye and touch. To form deeper marks with the laser engraver, one can repeat with several passes. Maximum engraving depth is 0.020″ in metals but can go as deep as 0.125″ in materials such as graphite.

Laser etching, which is a subset of laser engraving, occurs when the heat from the beam causes the surface of the material to melt. The laser beam uses high heat to melt the surface of the material. The melted material expands and causes a raised mark. Unlike with engraving, the depth in etching is typically no more than 0.001″ or it removes 0.001″ or less of the material. A laser etcher changes the surface finish of metals, and as such it may alters reflectivity and enhance contrast.

In the present invention, a laser produced marking is preferably utilized for providing graphics, text or any combination (e.g., a logo) on a portion of the outer surface of the razor blade, which may generally be coated with one or more hard coatings, such as Chromium or other known coatings. The marking serves as a good identifier of a manufacturer's products. The laser marking process can also produce an accurate date code. In addition, the laser marking system provides multiple artwork opportunities.

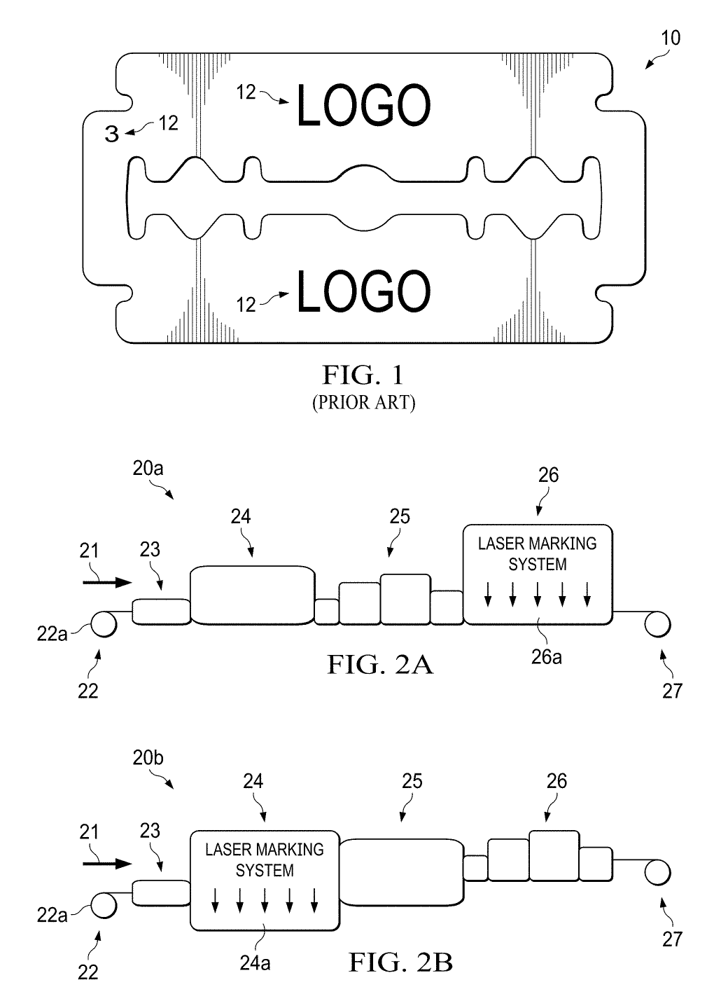

Referring to FIG. 1, a double edge razor blade 10 or the prior art is shown having ink produced markings 12. The markings 12 are deposited by a printing process using a printer with ink such as solvent-based ink. These inks are currently applied onto the surfaces of the blade edges via a printer and printing processes. In some instances, both sides are marked with the ink. The ink markings are typically trademark names (e.g., GILLETTE®), other text, designs and/or graphics.

As noted above, there are several disadvantages with the prior art printing processes. One disadvantage of the prior art ink markings is a safety issue caused by the hazardous attribute of the printing solvent based-ink itself and solvent thinners. The ink material can be considered harmful if inhaled and highly flammable. Another disadvantage is that in some instances, the marking is removed from the blade and therefore may not be permanent. In other instances, the marking is inconsistent. With some types of printers, the energy utilized for printing ink processes is excessive. Also, prior art printers have some constraints in that the date codes printed on the blade edges are precise only equal to the amount of times you physically change the rubber printer stamp (e.g., CYREL®) fixed to the printer wheel. In most instances, the date code has to be designed in when each rubber stamp is made and thus will not be updated until a new stamp is utilized.

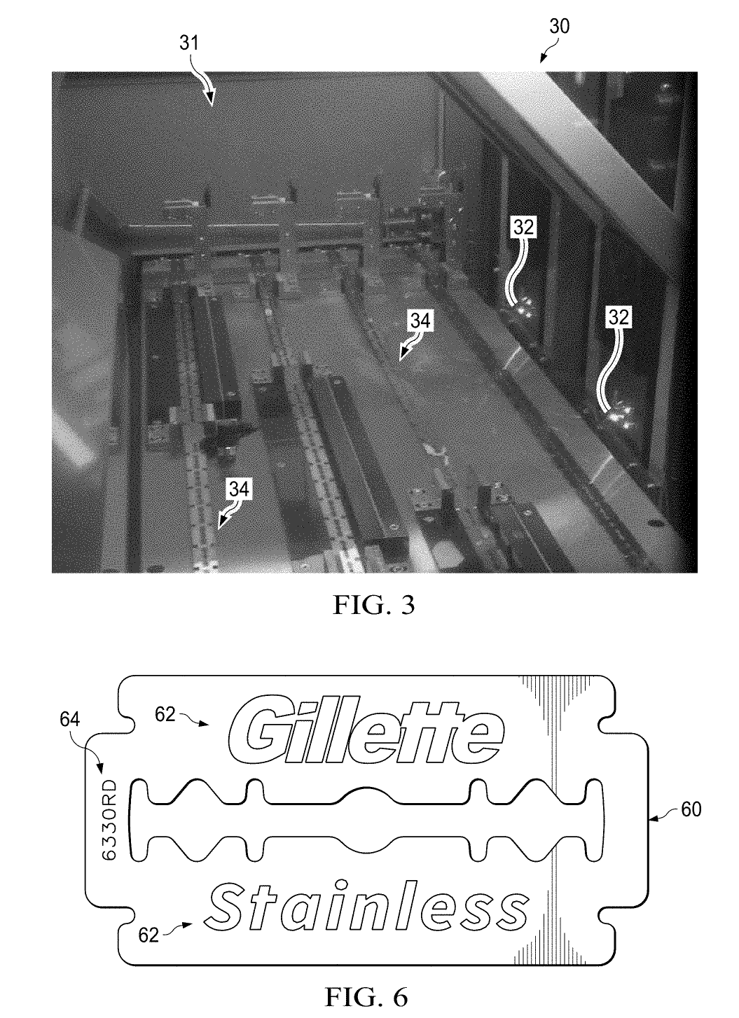

Referring to FIG. 2A, the novel process 20a of the present invention is depicted proceeding in-line in the direction of process arrow 21. At step 22, coils of stainless steel 22a used in production to form the final razor blades are unwound. At step 23, the steel strips are perforated. After perforation, the strips may be hardened, desirably including initially washing the perforated strips at step 24. The hardening step 25 may involve a furnace and quenching, freezing, and tempering of the steel strips 22a.

In FIG. 2A, the laser marking step 26 occurs after the hardening step 25. At step 26, the perforated strips 22a will be disposed in the laser marking system 26a and exposed to one or more lasers to achieve the laser produced markings on surfaces of the perforated strips.

In FIG. 2B, the novel process 20b of the present invention is depicted proceeding in-line in the direction of process arrow 21. At step 22, coils of stainless steel 22a used in production to form the final razor blades are unwound. As with FIG. 2A, at step 23, the steel strips are perforated. After perforation, the laser marking step 24 of the present invention occurs. At step 24, the perforated strips 22a will be disposed in the laser marking system 24a and exposed to one or more lasers to achieve the laser produced markings on surfaces thereon. After the laser marking step 24, the laser marked perforated strips are desirably washed at step 25. They then proceed to the hardening step 26 which may involve a furnace and quenching, freezing, and tempering of the steel strips 22a.

Thus, it is contemplated in the present invention that the strips 22a may be laser marked either before or after the hardening steps. Though not shown, in an alternate embodiment of the present invention, the perforated strips of may be laser marked substantially simultaneously with the hardening step as well.

Regardless of whether the strips are laser marked before, after, or simultaneously with the hardening step, preferably, in accordance with the present invention, the strips will be exposed to the laser marking system to achieve the laser produced markings, after the perforation step 23.

A novel aspect of the invention is that the laser marking step occurs when the blades are coupled or connected together rather than occurring on singular or individual blades. In the most preferred embodiment, the steel is in strip form when the laser marking step occurs.

After the laser marking step (e.g., step 26 of FIG. 2A or step 24 of FIG. 2B), the strips are rewound at step 27. It follows that other process steps, such as sharpening, singulating, or coating, are contemplated and may occur before or after any of the steps described herein.

Turning now to FIG. 3, a laser marking system 30 of the present invention is shown. The chamber interior 31 of the laser marking system 30 of the present invention is of the type described in FIG. 2A or FIG. 2B. In FIG. 3, several lines of perforated strips 34 are shown travelling through the chamber 31 of the laser marking system 30. Lasers 32 are directed to the strips. The red light shown in the representative photo represents the vision system lighting.

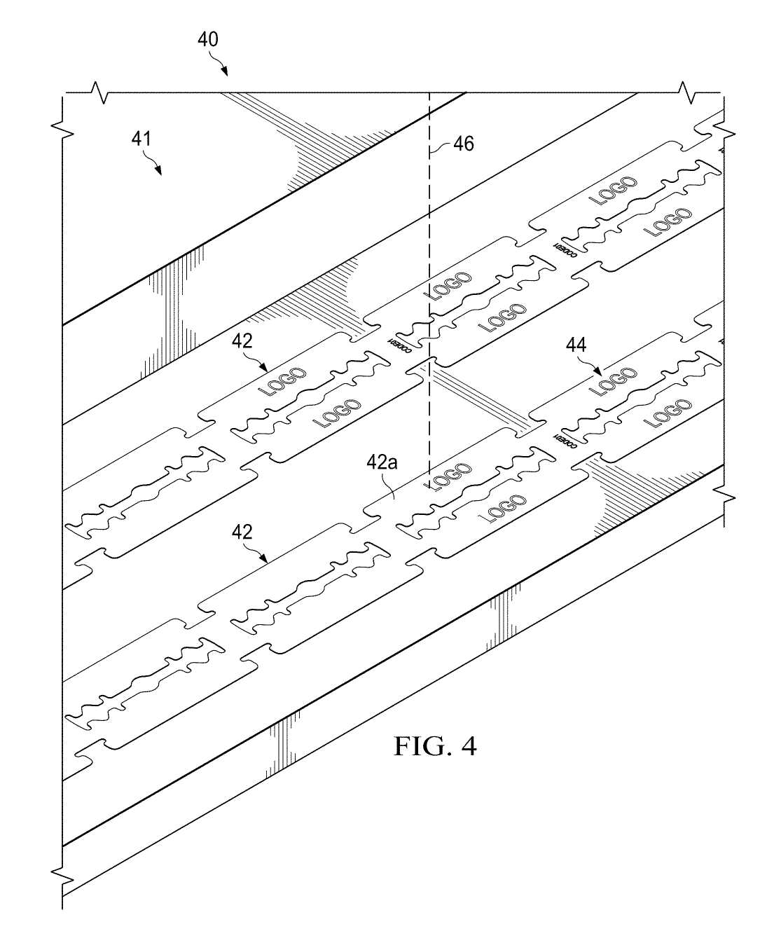

In FIG. 4, the chamber interior 41 of a laser marking system 40 (of the type described in FIG. 2A or FIG. 2B) of the present invention is shown. In FIG. 4, a close-up view of two lines of perforated strips 42 are shown travelling in line through the chamber 41 of the laser marking system 40. Lasers 46 are directed to the outer surfaces 42a of the strips 42 to produce markings 44.

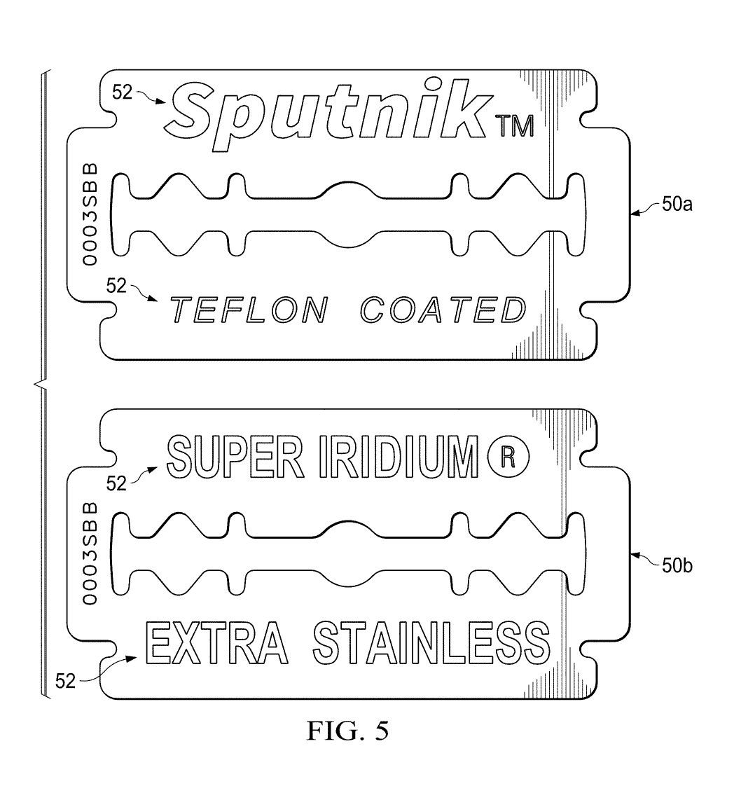

The laser marking process of the present invention generally produces markings 44 on one side of the razor blade. While the marking may be disposed anywhere on the blade, preferably the laser markings 44 are disposed on an exterior surface of the body of the blade as depicted in the examples of FIG. 5. The markings may also be disposed on the cutting edge of the blade (not shown).

In FIG. 5, two examples of laser marked double edge razor blades are shown. In razor blade 50a of the present invention, laser markings 52 are shown. One marking is the trademark name “Sputnik” and the other recites “Teflon coated” indicating a type of coating disposed on the blade 50a. In razor blade 50b of the present invention, laser markings 52 are also shown. One marking is the trademark name “Super Iridium” and the other recites “Extra Stainless” indicating a type of steel disposed on the blade 50a. Any type of laser marking may be disposed on the razor blades.

In FIG. 6, a double edge razor blade 60 of the present invention is shown having laser markings 62 and 64. One type of marking 62 is the trademark name “Gillette” indicating the source, while another marking shown recites “Stainless” indicating a type of steel disposed on the blade 60.

Date code 64 is another laser marking disposed on the razor blade 60 in FIG. 6. Date code 64 represents an accurate date in code format and is shown disposed on the left side of the blade 60 and transverse to the cutting edges. While a six digit date code 64 is shown in FIG. 6, any number of digits may be utilized for the date code marking. In the illustrative example of date code marking 64 of blade 60 in FIG. 6, progressing from left to right, the first number represents the last digit of the year (e.g., 6 is shown for year 2016), the next three digits represent the ordinal number of the day of the year (e.g., out of a total of 365 days), and the last two numbers may generally represent a location and/or machine that produced the blade.

The ability to dispose an accurate date code is remarkably accomplished via the laser marking process, providing an advantage over the prior art shown in FIG. 1 for instance. The present invention is arranged such that the process utilizes an automatic date retrieval system from a clock of a laser or a laser systems internal clock or in some instances, the main control system, and is thus always accurate. The laser produced date code marking provides improved traceability of the razor blades.

The laser markings described herein do not deform the blades. Many variables of the laser system are tuned to perform adequate laser marking on the razor blades in strip format. One factor is speed. The laser marking system is generally desired to run in-line and at speeds greater than or equal to prior art process speeds (e.g., ink printing processes). The present invention laser marking system desirably balances variables such as laser power, head speed and focus to create a satisfactory mark or logo on the surface of the razor blade.

What is claimed is:

1. A method of providing a marking on razor blades comprising the steps of:
providing one or more lasers, said one or more lasers producing one or more markings on said razor blades, said razor blades connected on at least one strip.

2. The method of claim 1 wherein said one or more laser produced markings are produced using a laser marking process, a laser etching process or a laser engraving process, or any combination thereof.

3. The method of claim 1 wherein said razor blades comprise double edge or single edge razor blades.

4. The method of claim 3 wherein said one or more laser produced markings are disposed on a body portion of each said razor blade on said at least one strip.

5. The method of claim 1 wherein said at least one strip of razor blades is comprised of steel.

6. The method of claim 5 wherein said one or more laser produced markings are formed on said at least one steel strip after a perforating process.

7. The method of claim 5 wherein said one or more laser produced markings are formed on said at least one steel strip before, after, or simultaneously with, a hardening process.

8. The method of claim 1 wherein one or more laser produced markings formed on surfaces of said razor blades on said at least one strip leave said surfaces intact.

9. The method of claim 5 wherein said steel strip is coated.

10. The method of claim 1 wherein said one or more markings comprise graphics, text, or any combination thereof.

11. The method of claim 10 wherein said one or more markings comprises an accurate date code.

12. The method of claim 11 wherein said accurate date code is disposed transverse to a cutting edge of the razor blade.

13. The method of claim 1 further comprising the steps of perforating, washing, or hardening said razor blades.

14. The method of claim 13 wherein said steps occur in an in-line system.

15. A razor blade comprising one or more markings disposed by one or more lasers, said laser markings disposed on a surface of a steel strip.

16. The razor blade of claim 15 wherein said steel strip is perforated.

17. The razor blade of claim 15 wherein said laser markings are applied to said razor blade, before, after, or simultaneous with, a strip hardening process.

18. The razor blade of claim 15 wherein said one or more markings are produced using a laser marking process, a laser etching process or a laser engraving process, or any combination thereof.

19. The razor blade of claim 15 wherein said razor blade comprises a double edge or a single edge razor blade.

20. The razor blade of claim 15 wherein said one or more markings are disposed on a body portion of said razor blade.

21. A razor blade comprising an accurate date marking.

22. The razor blade of claim 21 wherein said accurate date marking is in a code format.

23. The razor blade of claim 22 wherein said accurate date code marking is disposed on a surface of said razor blade using one or more lasers.

24. The razor blade of claim 23 wherein a clock of the one or more lasers is used to provide an accurate date for the date marking.

25. The razor blade of claim 23 wherein said accurate date marking is disposed transverse to a cutting edge of the razor blade.
